(19) United States
(12) Patent Application Publication
(10) Pub. No.: US 2007/0204436 A1
(43) Pub. Date: Sep. 6, 2007

(54) Handle

(76) Inventor: Yu-Tzu Wang, Taipei City (TW)

Correspondence Address: BIRCH STEWART KOLASCH & BIRCH, PO BOX 747, FALLS CHURCH, VA, 22040-0747, US

(21) Appl. No.: 11/365,865

(22) Filed: Mar. 2, 2006

(51) Int. Cl. E05B 1/00

(52) U.S. Cl. 16/436

(57) ABSTRACT

A handle includes a metal frame with a first end and a second end connecting by a pair of opposing upper and lower bridge plates that form a carved out space between them, a wooden base wedged in the carved out space and a pair of wooden side plates formed in a symmetrical shape on the left side and right side that have a selected height and at least one planar surface to be bonded to one side of the wooden base that is exposed outside the metal frame after being wedged. Thereby the handle is formed and consists of the metal frame and wooden base and side plates in an integrated manner.

### BACKGROUND OF THE INVENTION

1. Field of the Invention

The present invention relates to a handle and particularly to a handle that provides a steady strength and reduces heat transfer.

2. Description of the Prior Art

The conventional kitchen utensils such as knifes, spatulas, forks, brushes and the like generally have a long arm to facilitate handling. In order to make grasping easier, a handle is formed on one end of the arm with a size greater than the arm. The handle usually is coupled on the arm externally and made from a different material. For instance, a wooden or plastic handle is coupled with a metal arm. Of course, the entire utensil may also be made from only one material, such as a metal knife or spatula.

The conventional kitchen utensils that have the arm and handle made from different materials and coupled together often encounter a problem, namely the coupling spot is prone to loosen off after used for a period of time. This mainly results from damaging of the wooden handle caused by the metal arm. Due to material characteristics, the wood and metal are difficult to form a firm coupling. Hence fastening by rivets is preferable to bonding by adhesive. This is why the conventional wooden handle usually has pins located thereon. However, even if the wooden handle and metal utensil are fastened by rivets, it still could loosen off after used for a period of time. This is especially true for the utensils that receive greater forces in use such as knifes.

To remedy the problem of loose coupling between the wooden handle and metal arm, one approach is to make the entire utensil from metal. But such a structure transfers heat rapidly when it is used for cooking, and grasping could be difficult. Moreover, the utensil made entirely from metal is more expensive than the one that has the handle made from wood.

### SUMMARY OF THE INVENTION

The primary object of the present invention is to solve the aforesaid problem of easy loosening on the coupling portion of the conventional wooden handle and metal arm by providing a simple handle that can couple two objects securely without loosening off and riveting.

Another object of the invention is to provide a handle that couples wood and metal securely to maintain the strength of the metal at a lower production cost than the metal handle.

To achieve the foregoing objects, the handle according to the invention couples wood and metal, and includes a metal frame which has a first end and a second end connected by a pair of opposing upper and lower bridge plates to form a carved out space between them, a wooden base which has selected length, width and height to be wedged in the carved out space in the metal frame, and a pair of wooden side plates formed in a symmetrical shape on the left side and the right side that have a selected height and at least one planar side to be bonded to two exposing sides of the wooden base after wedged in the metal frame so that a complete handle consisting of the metal frame, wooden base and side plates is formed.

The handle thus constructed has the wooden base wedged in the carved out space in the metal frame and a pair of wooden side plates with the planar sides bonding to the exposing sides of the wooden base. Hence the metal frame covers the wooden base and the wooden side plates seal two sides of the metal frame to form a closed structure without using any rivet. The wood and metal are coupled securely and can prevent loosening happened to rivet fastening.

On the handle consisting of wood and metal of the invention, the metal frame has an elongate arm extended from the first end. As the elongate arm and the grasping portion are formed by extending from the same material, the main force exerting and receiving portion of the utensil concentrates on the metal frame, while the wooden side plates are merely for grasping, hence loosening that might otherwise occur to two different materials after using for a period of time can be prevented.

Moreover, the handle consisting of wood and metal mentioned above can be made at a lower cost than the handle made entirely from metal.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the handle of the invention.

FIG. 2 is a perspective view of the handle of the invention showing a cross section.

FIG. 3 is a perspective view of the handle of the invention.

FIG. 4 is a schematic view of the invention adopted for a brush.

FIG. 5 is a schematic view of the invention adopted for a knife.

### DESCRIPTION OF THE PREFERRED EMBODIMENTS

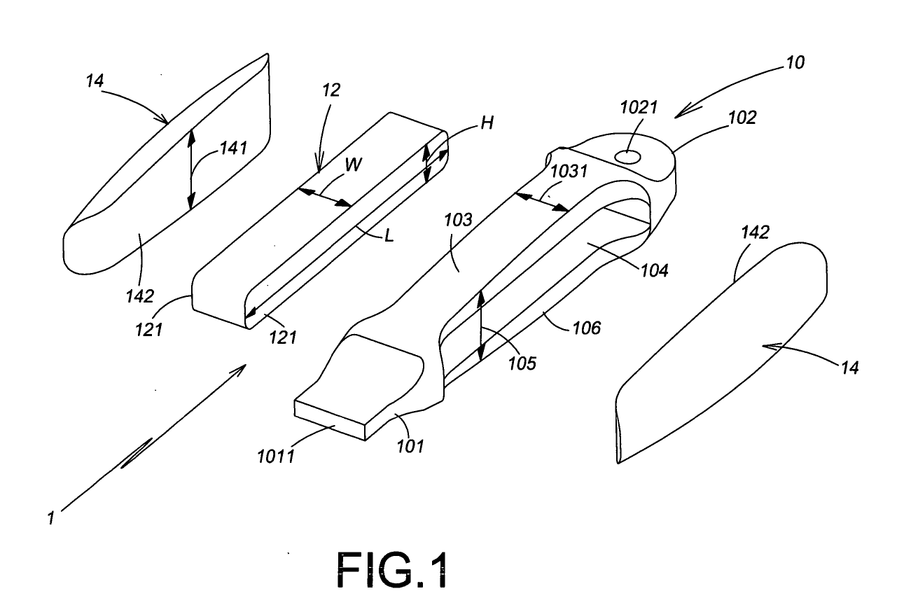

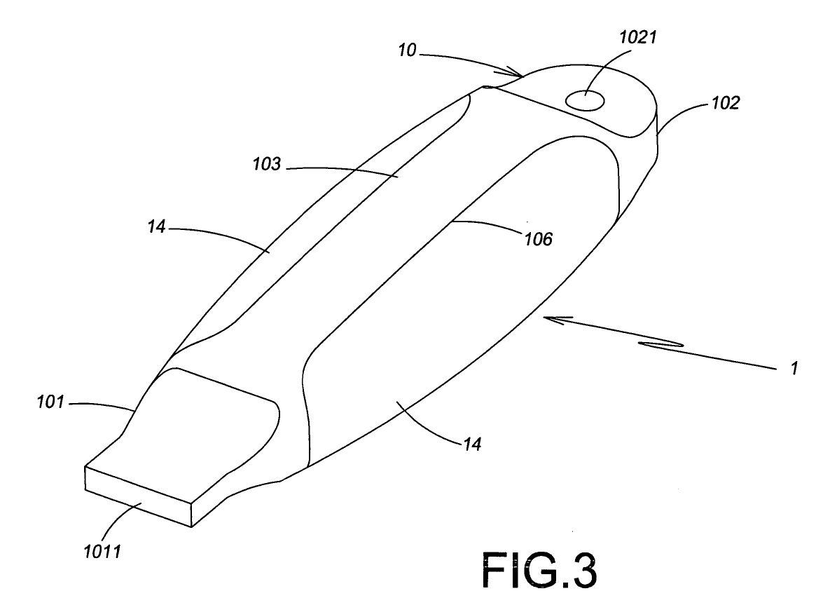

Refer to FIGS. 1, 2 and 3 for an embodiment of the invention. The handle 1 includes a metal frame 10, a wooden base 12 and a pair of side plates 14. The metal frame 10 is integrally formed and has a first end 101 and a second end 102 that are connected by a pair of opposing upper and lower bridge plates 103. The upper and lower bridge plates 103 form a carved out space 104 between them.

The wooden base 12 has selected length, width and height. The length L is preferably same or slightly less than the interval of the first and second ends 101 and 102 of the metal frame 10. The width W of the wooden base 12 is preferably same as the width 1031 of the bridge plates 103. The height H of the wooden base is preferably same or slightly less than the interval of the upper and lower bridge plates 103. Thus the wooden base 12 can be wedged in the space 104 of the metal frame 10.

The side plates 14 are formed in a symmetrical shape on the left side and right side. They have a selected height 141 which is preferably same as a height 105 of the outmost surfaces of the two bridge plates 103. In this embodiment, the side plates 14 are preferably made from wood.

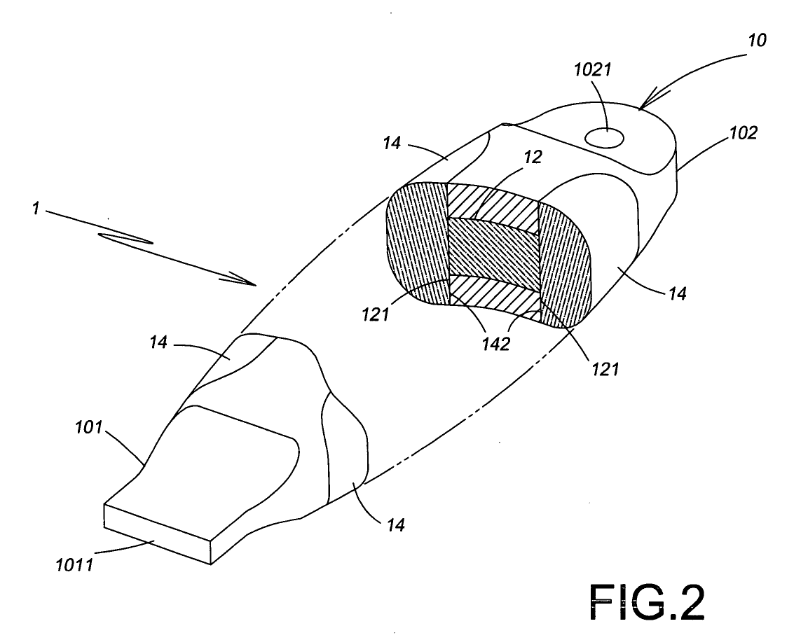

By means of the aforesaid construction, the wooden base 12 can be wedged securely in the space 104 of the metal frame 10 without any bonding material. Moreover, the wooden base 12 has two side surfaces 121 (referring to FIG. 2) exposing outside of the metal frame 10 to be coated with adhesive. Or the side plates 14 have a planar side 142 also coated with the adhesive, then the planar side 142 of the side plates 14 and the side surface 121 of the wooden base 12 can be bonded together to form the handle 1 consisting of the metal frame 10, wooden base 12 and side plates 14.

In the embodiment previously discussed, the metal frame 10 is formed by connecting the first and second ends 101 and 102 through the bridge plates 103. The widest width 1031 of the bridge plates 103 equals to the width of the first and second ends 101 and 102. If the width 1031 of the bridge plates 103 is smaller than the width of the first and second ends 101 and 102 (as shown in FIGS. 1, 2 and 3), a trough 106 is formed on the metal frame 10 on the coupling portion of the first and second ends 101 and 102 and the bridge plates 103, then the bonding side of the side plates 14 and the wooden base 12 has to be formed with a shape corresponding to the trough 106 of the metal frame 10. Hence only the wooden side plates 14 and the wooden base 12 of the same material are bonded together. Therefore it looks like the wooden side plates 14 are directly bonded to the metal frame 10, and provides a visual sense of integrating wood and metal.

In the embodiment set forth above, the second end 102 of the metal frame 10 may have a through hole 1021 formed thereon to facilitate hanging of the handle 1 on any hook mounted onto a wall (not shown in the drawings).

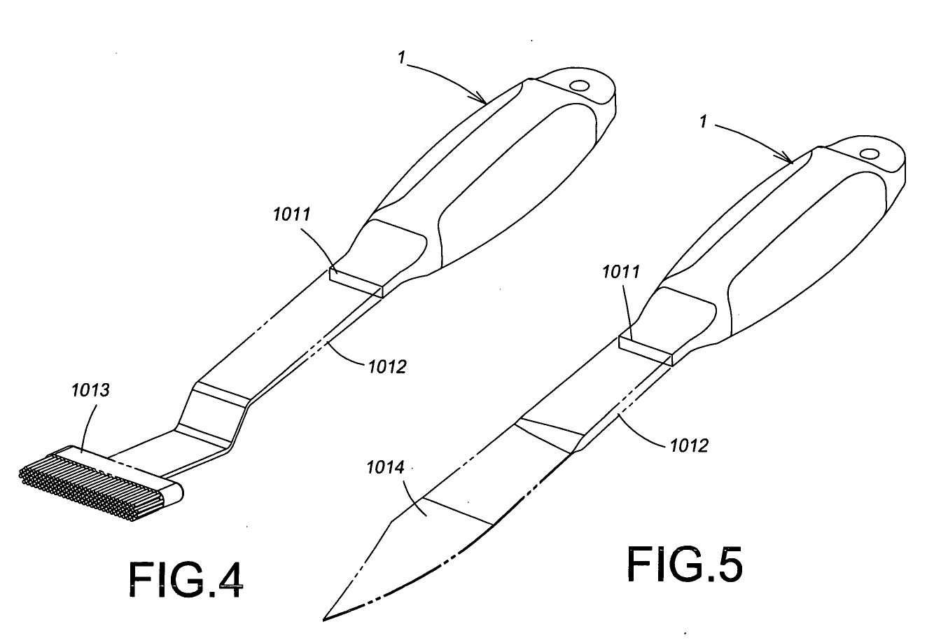

When the handle 1 previously discussed is in use, the first end 101 of the metal frame 10 has an open distal end 1011 which may be extended to a selected length 1012. On a distal end of the extended length 1012, a brush 1013 as shown in FIG. 4 or a knife 1014 as shown in FIG. 5, or any other applicable tool may be formed.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. A handle, comprising:
a metal frame having a first end and a second end connecting by a pair of opposing upper and lower bridge plates that form a carved out space between them;
a wooden base having selected length, width and height to be wedged in the carved out space of the metal frame; and
a pair of wooden side plates formed in a symmetrical shape on a left side and a right side having a selected height and at least one planar side to be bonded to two sides of the wooden base exposing outside the metal frame after having wedged in the metal frame to form the handle.

2. The handle of claim 1, wherein the metal frame is integrally formed.

3. The handle of claim 1, wherein the wooden base has a length equal to the interval of the first end and the second end of the metal frame, a width equal to the width of the bridge plates and a height equal to the interval of the bridge plates.

4. The handle of claim 1, wherein the side plates has a height equal to the height of the outmost surfaces of the two bridge plates.

5. The handle of claim 1, wherein the width of the bridge plates is smaller than the width of the first end and the second end to form a trough on the metal frame.

6. The handle of claim 5, wherein the side plates and the wooden base are bonded on one side which is formed in a shape corresponding to the trough of the metal frame.

7. The handle of claim 1, wherein the second end of the metal frame has a through hole to be hung on a hook mounted onto a wall.

8. The handle of claim 1, wherein the first end has an open distal end extended for a selected length.

9. The handle of claim 8, wherein the extended length of the first end has another distal end to form a brush.

10. The handle of claim 8, wherein the extended length of the first end has another distal end to form a knife.

11. The handle of claim 8, wherein the extended length of the first end has another distal end to form a desired tool in a usable shape.
